(19) United States
(12) Patent Application Publication
(10) Pub. No.: US 2019/0163806 A1
(43) Pub. Date: May 30, 2019

(54) METHOD OF CORRELATING TIME-SERIES DATA WITH EVENT DATA AND SYSTEM THEREOF

(71) Applicant: AGT INTERNATIONAL GMBH, Zurich (CH)

(72) Inventors: Alexander BAUER, Darmstadt (DE); Holger ZIEKOW, Frankfurt (DE)

(21) Appl. No.: 15/824,476

(22) Filed: Nov. 28, 2017

(51) Int. Cl. G06F 17/30

(52) U.S. Cl. CPC G06F 17/30598

(57) ABSTRACT

A method and system of correlating observations recorded by one or more sensors with occurrences of one or more events, comprising obtaining data informative of the observations, each observation associated with a time; obtaining data informative of the one or more events, each event associated with a label characterizing the event and a time range informative of the time of occurrence of the event, including at least a start time and an end time; assigning to each of a plurality of observations one or more labels associated with a respective one or more events that match the time of the observation; clustering the observations into a set of clusters based, at least partly, on the assigned labels; correlating one or more clusters with corresponding events; and generating output indicative of at least one such correlation.

### TECHNICAL FIELD

The presently disclosed subject matter relates generally to processing time-series data, and in particular to correlating time-series data with event data.

### BACKGROUND

Time-series data refers to data representative of a series of observations recorded over time by one or more sensors. Examples of observations that can be recorded by a sensor include, e.g., power consumption of an electronic device, temperature of a central processing unit (CPU), volumetric flow rate of a fluid, etc. The recorded observations can also be binary, e.g. lights on/lights off, motion detected/no motion detected, etc. Often, the observations exhibit a certain pattern which can be linked to the occurrence of certain events that can explain the pattern.

For example, we might observe that computer usage in an office building is relatively low during the evening and night time hours, and relatively high during the day time hours. We might further observe a pattern in which every sixth day and seventh day in a repeating seven-day cycle, computer usage in the building is relatively consistent, and low, during both the daytime and night time hours. This pattern can be explained with the prior knowledge that the sixth and seventh day of each week are non-working days, i.e. weekend days.

However it remains a challenge to correlate time-series data with the occurrence of events unsupervisedly. That is, absent such prior knowledge about events that might explain the data.

### GENERAL DESCRIPTION

According to one aspect of the presently disclosed subject matter there is provided a system for correlating observations recorded by one or more sensors with occurrences of one or more events, comprising one or more data repositories; and a processing unit operatively coupled to the one or more data repositories and configured to: obtain from at least one of the one or more data repositories a first data set comprising data informative of the observations, each observation associated with a time; obtain from at least one of the one or more data repositories a second data set comprising data informative of the one or more events, each event associated with a label characterizing the event and a time range informative of the time of occurrence of the event, including at least a start time and an end time; assign to each observation of a plurality of observations in the first data set one or more labels associated with a respective one or more events that match the time of the observation, wherein an event matches the time of an observation whenever the time associated with the observation is within the time range associated with the event; cluster the plurality of observations into a set of clusters based, at least partly, on the assigned labels; correlate one or more clusters with corresponding events by: i) calculating, for each cluster-label pair comprising a given cluster in the set of clusters and a given label in a set of candidate labels, a value indicative of a correlation between the cluster and the label in the cluster-label pair; ii) selecting one cluster-label pair for each cluster, the selected cluster-label pair for a given cluster being the pair resulting in the highest value from amongst all other cluster-label pairs comprising the given cluster; iii) for each selected cluster-label pair in respect of which the resulting value is above a predetermined threshold, determining that the cluster is correlated with the event with which the label is associated; and generate output indicative of at least one such correlation.

In addition to the above features, the system according to this aspect of the presently disclosed subject matter can comprise one or more of features (i) to (viii) listed below, in any desired combination or permutation which is technically possible:

(i) the processing unit is configured to cluster the plurality of observations into a set of clusters by: (a) selecting a clustering configuration proposal from a clustering configuration space comprising one or more predetermined clustering configurations; (b) clustering the observations in accordance with the obtained clustering configuration proposal; (c) evaluating a quality measure of the clustering using a metric that considers the observations and the labels assigned thereto; and (d) iterating through steps (a) to (c) until a stopping criterion is satisfied;

(ii) the metric is a modified Silhouette score such that the distance function of the Silhouette score also considers the distance between labels;

(iii) the stopping criterion is satisfied upon one or more of: (a) a value indicative of the quality measure breaching a predetermined threshold; (b) the number of iterations breaching a predetermined threshold; and (c) the number of consecutive iterations with no improvement to a value indicative of the quality measure breaching a predetermined threshold;

(iv) the clustering configuration proposal is selected using one or more of a grid search, random search, and Bayesian optimization;

(v) the processing unit is configured to cluster the plurality of observations into a set of clusters by: generating a distance matrix indicative of distances between all pairs of observations or pairs of vectors of observations, said distances also considering the labels assigned to the pairs of observations or pairs of vectors of observations, and clustering the plurality of observations in accordance with said distance matrix using a distance-matrix based clustering algorithm;

(vi) the set of candidate labels for a given cluster is selected from the group consisting of: i) all labels, and ii) only those labels assigned to at least one observation in the given cluster;

(vii) the value indicative of a correlation comprises one of a Phi coefficient and a Jaccard similarity coefficient; and

(viii) each observation relates to an activity in a daily routine of an individual, and each event is obtained from the individual's calendar, and wherein the correlated data is used to determine a linkage between certain events and certain activities in the individual's daily routine, or each observation relates to a usage of a device in an environment, and each event is obtained from one or more calendars of persons in the environment, and wherein the correlated data is used to determine a linkage between certain events and the usage of devices in the environment.

According to another aspect of the presently disclosed subject matter there is provided a method of correlating observations recorded by one or more sensors with occurrences of one or more events, comprising, by a processing unit operatively coupled to one or more data repositories: obtaining from the one or more data repositories a first data set comprising data informative of the observations, each observation associated with a time; obtaining from the one or more data repositories a second data set comprising data informative of the one or more events, each event associated with a label characterizing the event and a time range informative of the time of occurrence of the event, including at least a start time and an end time; assigning to each observation of a plurality of observations in the first data set one or more labels associated with a respective one or more events that match the time of the observation, wherein an event matches the time of an observation whenever the time associated with the observation is within the time range associated with the event; clustering the plurality of observations into a set of clusters based, at least partly, on the assigned labels; correlating one or more clusters with corresponding events by: i) calculating, for each cluster-label pair comprising a given cluster in the set of clusters and a given label in a set of candidate labels, a value indicative of a correlation between the cluster and the label in the cluster-label pair; ii) selecting one cluster-label pair for each cluster, the selected cluster-label pair for a given cluster being the pair resulting in the highest value from amongst all other cluster-label pairs comprising the given cluster; iii) for each selected cluster-label pair in respect of which the resulting value is above a predetermined threshold, determining that the cluster is correlated with the event with which the label is associated; and generating output indicative of at least one such correlation.

This aspect of the disclosed subject matter can comprise one or more of features (i) to (viii) listed above with respect to the system, mutatis mutandis, in any desired combination or permutation which is technically possible.

According to another aspect of the presently disclosed subject matter there is provided a non-transitory storage medium comprising instructions that when executed by a processing unit, cause the processing unit to perform a method of correlating observations recorded by one or more sensors with occurrences of one or more events, the method comprising: obtaining from one or more data repositories a first data set comprising data informative of the observations, each observation associated with a time; obtaining from one or more data repositories a second data set comprising data informative of the one or more events, each event associated with a label characterizing the event and a time range informative of the time of occurrence of the event, including at least a start time and an end time; assigning to each observation of a plurality of observations in the first data set one or more labels associated with a respective one or more events that match the time of the observation, wherein an event matches the time of an observation whenever the time associated with the observation is within the time range associated with the event; clustering the plurality of observations into a set of clusters based, at least partly, on the assigned labels; correlating one or more clusters with corresponding events by: i) calculating, for each cluster-label pair comprising a given cluster in the set of clusters and a given label in a set of candidate labels, a value indicative of a correlation between the cluster and the label in the cluster-label pair; ii) selecting one cluster-label pair for each cluster, the selected cluster-label pair for a given cluster being the pair resulting in the highest value from amongst all other cluster-label pairs comprising the given cluster; iii) for each selected cluster-label pair in respect of which the resulting value is above a predetermined threshold, determining that the cluster is correlated with the event with which the label is associated; and generating output indicative of at least one such correlation.

This aspect of the disclosed subject matter can comprise one or more of features (i) to (viii) listed above with respect to the system, mutatis mutandis, in any desired combination or permutation which is technically possible.

Among advantages of certain embodiments of the presently disclosed subject matter is the capability of unsupervisedly identifying causal links between time-series data and events that can explain the reason for the time-series data.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a functional block diagram of a time-series data processing system, in accordance with certain embodiments of the presently disclosed subject matter;

FIG. 2 illustrates a generalized flow chart of processing time-series data, in accordance with certain embodiments of the presently disclosed subject matter;

FIG. 3 illustrates example observations to be processed in accordance with certain embodiments of the presently disclosed subject matter;

FIG. 4A illustrates a generalized flow chart of clustering time-series data in accordance with a first embodiment of the presently disclosed subject matter;

FIG. 4B illustrates a generalized flow chart of clustering time-series data in accordance with a second embodiment of the presently disclosed subject matter; and

FIG. 5 illustrates a method of correlating the data in a cluster with an event, in accordance with certain embodiments of the presently disclosed subject matter.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “clustering”, “associating”, “obtaining”, “defining”, “pairing”, “evaluating”, “comparing”, “correlating”, “selecting”, “assigning” or the like, refer to the action(s) and/or process(es) of a computer that manipulate and/or transform data into other data, said data represented as physical, such as electronic, quantities and/or said data representing the physical objects. The term “computer” should be expansively construed to cover any kind of electronic device with data processing capabilities including, by way of non-limiting example, the behavior analysis system disclosed in the present application.

The terms “non-transitory memory” and “non-transitory storage medium” used herein should be expansively construed to cover any volatile or non-volatile computer memory suitable to the presently disclosed subject matter.

The term “criterion” used in this patent specification should be expansively construed to include any compound criterion, including, for example, several criteria and/or their logical combinations.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages can be used to implement the teachings of the presently disclosed subject matter as described herein.

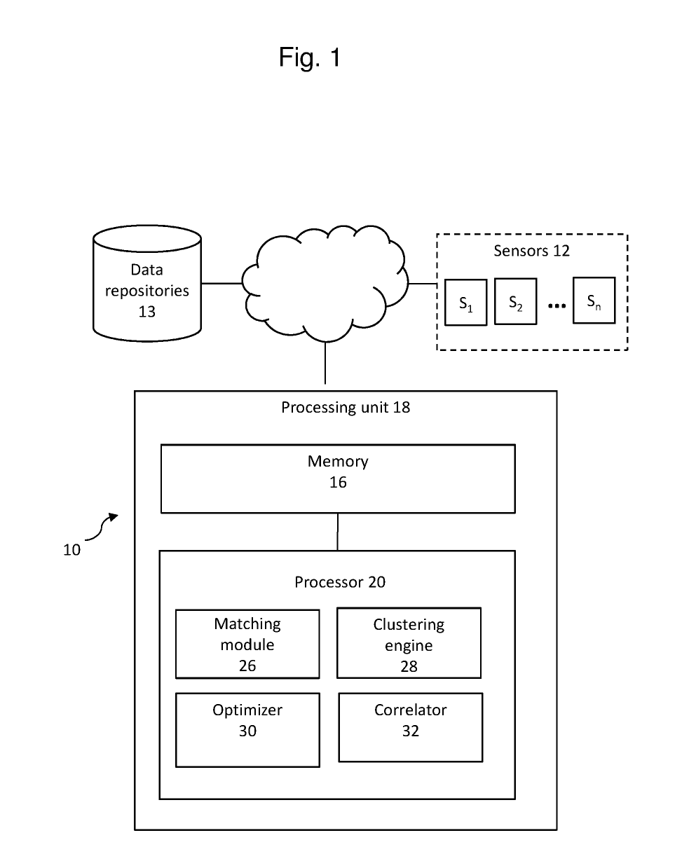

Bearing this in mind, attention is drawn to FIG. 1 illustrating a functional block diagram of a time-series data processing (DP) system (10). The illustrated DP system comprises one or more data repositories (13). At least one data repository has stored therein a first data set, being data informative of a plurality of observations recorded over time (hereinafter “time-series data”) by one or more of sensors (12). At least one data repository has stored therein a second data set, being data informative of a plurality of events (hereinafter “event data”). The at least one data repository having event data stored therein can be the same or different from the at least one data repository having the time-series data stored therein. That is, in certain embodiments, the time-series data and the event data can be physically stored on the same data repository or group of data repositories, or they can each be stored on physically separate data repositories or groups of data repositories. In certain embodiments, the time-series data can be stored and/or accessible via one or more log files, and the event data can be stored and/or accessible via one or more calendars (e.g. MS Outlook calendar, Google calendar, etc.). It should be noted that the one or more data repositories (13) can physically reside on the same computer or different computers. Further, one or more of the data repositories (13) can be distributed amongst a plurality of physically separated computers.

Many different kinds of sensors (12) are applicable to the invention detailed herein, depending on the specific embodiment, including without limitation, sensors for temperature, humidity, oxygen level, pH, depth, wind, rain, speed, acceleration, movement, light, sound, pressure, etc. The sensors may be used in a large spectrum of appliances: indoor, outdoor, various industrial appliances, mobile phones, vehicle mounted, person mounted, to mention a few examples. Each sensor records a measurement value at a certain time, and records many such measurements over time. Each measurement is “sensed” by the respective sensor at a given time and a value indicative of the measurement is recorded in the one or more data repository in association with the given time. Hereinafter the term “observation” is used to refer to a measurement value or a value derived from a series of measurement values (e.g. the mean, sum, or variance of a set of measurements, etc.). In certain embodiments, some or all of the observations can be continuously recorded by the respective sensors at a regular sampling rate.

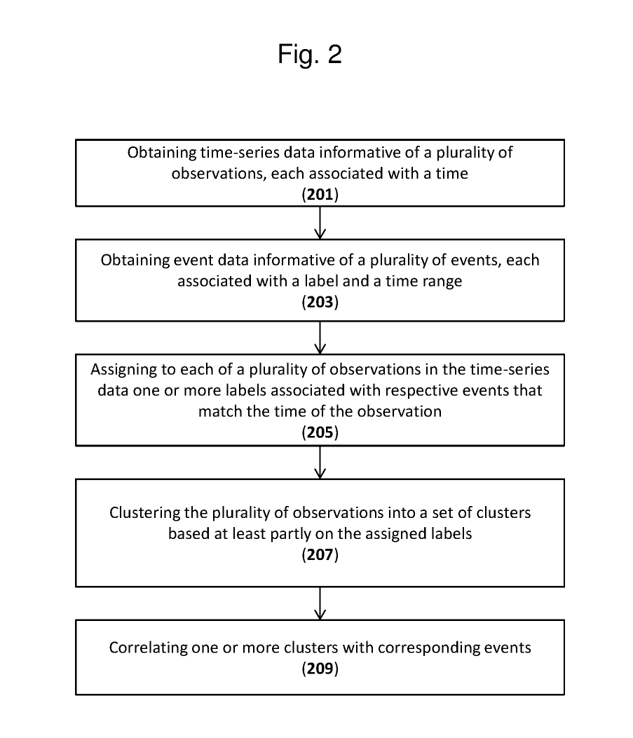

The DP system (10) further comprises a processing unit (18) configured to obtain time-series data and event data from the one or more data repositories (13) and to process the time-series data by correlating the time-series data to event data, as will further be detailed below with reference to FIG. 2. Processing unit (18) comprises a processor (20) configured to perform a series of operations in accordance with computer-readable instructions for performing the method of processing time-series data detailed herein. Such operations can be performed using one or more functional modules, and such functional modules are referred to hereinafter as being comprised in the processor. In certain embodiments, the processor can comprise such functional modules as, e.g., a matching module (26) configured to match time-series data to event data, a clustering engine (28) configured to cluster the time-series data in accordance with the event data matched thereto, an optimizer (30) configured to evaluate the quality of the clustering taking into account the time-series data and the event data, and a correlator (32) configured to correlate clusters of time-series data with events. Processing unit (18) can further comprise a non-transitory computer-readable storage medium, such as the illustrated memory (16), configured to store computer-readable instructions.

DP system (10) can further include such other components as an I/O interface (not shown) configured to enable input/output operations, and a communication interface (not shown) configured to enable data communication between different components of the DP system which may reside on different physical machines and may communicate with one another via a wired and/or wireless computer network.

It is noted that the teachings of the presently disclosed subject matter are not bound by the DP system described with reference to FIG. 1. Equivalent and/or modified functionality can be consolidated or divided in another manner and can be implemented in any appropriate combination of software with firmware and/or hardware and executed on a suitable device. Those skilled in the art will also readily appreciate that the data repositories can be consolidated or divided in other manner; databases can be shared with other systems or be provided by other systems, including third party equipment.

FIG. 2 illustrates a generalized flow chart of processing time-series data by correlating the time-series data to event data in accordance with certain embodiments of the presently disclosed subject matter. In certain embodiments, processing unit (18) obtains (201) the time-series data from one or more data repositories (13). As detailed above, the time-series data is informative of a plurality of observations, each observation associated with a time.

In certain embodiments, obtaining time-series data can include “chopping up” or dividing a stream of time-series data into “chunks” of discrete time-series vectors, each vector comprising observations recorded during a fixed time period, e.g. using techniques known to persons skilled in the art. These techniques can include, e.g. using a fixed length hopping window aligned to absolute time, using variable length hopping windows defined according to the start and end time of events, or using fixed length windows aligned to a relative point in time, etc. In certain embodiments, high level complex event processing languages can be used to define window sizes, how windows move through time, or to extract chunks that are determined by predefined start and stop events. In certain embodiments, the time-series data acquired from different sensors, can be “aligned”, i.e., the observations recorded by different sensors in a defined time period are collected into a single data structure.

Processing unit (18) further obtains (203) event data from data repositories (13), informative of a plurality of events, each associated with a label (e.g. a textual label) characterizing the event (e.g. by providing a simple description of the event) and a time range informative of the time of occurrence of the event (e.g. a start time and an end time timestamps, start time timestamp in combination with event duration, start time only when the duration of event is not important or implied, etc.).

Processing unit (18), e.g. matching module (26), assigns (205) to each of a plurality of observations one or more labels associated with respective events that match the time of the observation, i.e. the time of the observation falls within the time range of the event. By way of non-limiting example, observations sensed between, e.g., 1:00 PM and 5:00 PM on a particular given day, would have assigned to it the label(s) of all events that started at or before 1:00 PM and ended at or after 5:00 PM on the given day.

In some cases, an observation can be assigned multiple labels, each pertaining to a matching event. In certain embodiments, as detailed above the time-series data can take the form of vectors of observations covering a fixed time period, in which case a label assigned to a vector is considered for the purposes of this description to be assigned to each observation in the vector.

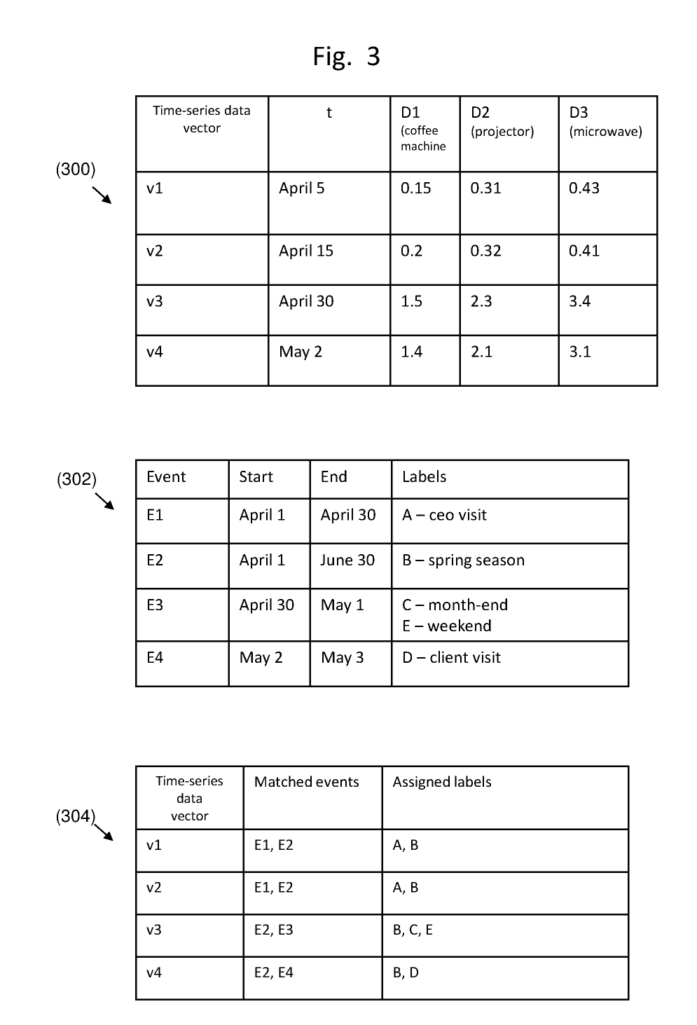

FIG. 3 illustrates a non-limiting example of assigning labels to observations. Table (300) lists four time-series vectors denoted ν₁, ν₂, ν₃ and ν₄. Each vector comprises observations informative of the total daily power consumption of each of each of three devices D1, D2 and D3, which for the purposes of this example correspond to the coffee machine (D1), projector (D2), and microwave (D3) in an office meeting room. Each of vectors ν₁, ν₂, ν₃ and ν₄ are associated with a particular day and comprise observations for a single day, thus the time t of each observation in each vector is in a unit of a day. It will be appreciated by one skilled in the art that while the example of FIG. 3 refers to observations made in respect of a number of different devices, in some cases a number of different observations can also be made in respect of the same device (e.g. a device's temperature, power, and humidity). It should further be appreciated that example detailed herein is provided for illustrative purposes, and should by no means be viewed as limiting any aspect of the presently disclosed subject matter.

Table (302) lists four events denoted E1, E2, E3 and E4 in which:
i) E1 is labelled “A”, (which can correspond to, e.g., a one-day CEO visit) and takes place between April 1-30;
ii) E2 is labelled “B”, (which can correspond to, e.g., spring season) and takes place between April 1-June 30;
iii) E3 is labelled “C”, (which can correspond to, e.g. month-end) and “E” (which can correspond to, e.g. weekend) and takes place between April 30-May 1; and
iv) E4 is labelled “D” (which can correspond to, e.g. client visit) and takes place between May 2-3.

It is noted that for the above event E1 the time range can be specified by a start time timestamp (e.g. April 30^{th}), while one-day duration is implied. Likewise, in the above event E3, the duration of “month-end” event and “weekend” is implied.

Table (304) illustrates how each vector is assigned one or more of labels “A”, “B”, “C”, “D” and “E” based on the time of the observations in the vector corresponding to the time of events E1-E4 associated with the labels. As shown in table (304):
i) ν₁ is assigned labels “A” and “B”, based on the time associated with ν₁ falling within the time range associated with events E1 and E2;
ii) ν₂ is also assigned “A” and “B”, based on the time associated with ν₂ falling within the time range associated with events E1 and E2;
iii) ν₃ is assigned “B”, “C”, and “E”, based on the time associated with ν₃ falling within the time range associated with events E2 and E3 (and, optionally, E1 and, accordingly A); and
iv) ν₄ is assigned “B” and “D”, based on the time associated with ν₄ falling within the time range associated with events E2 and E4.

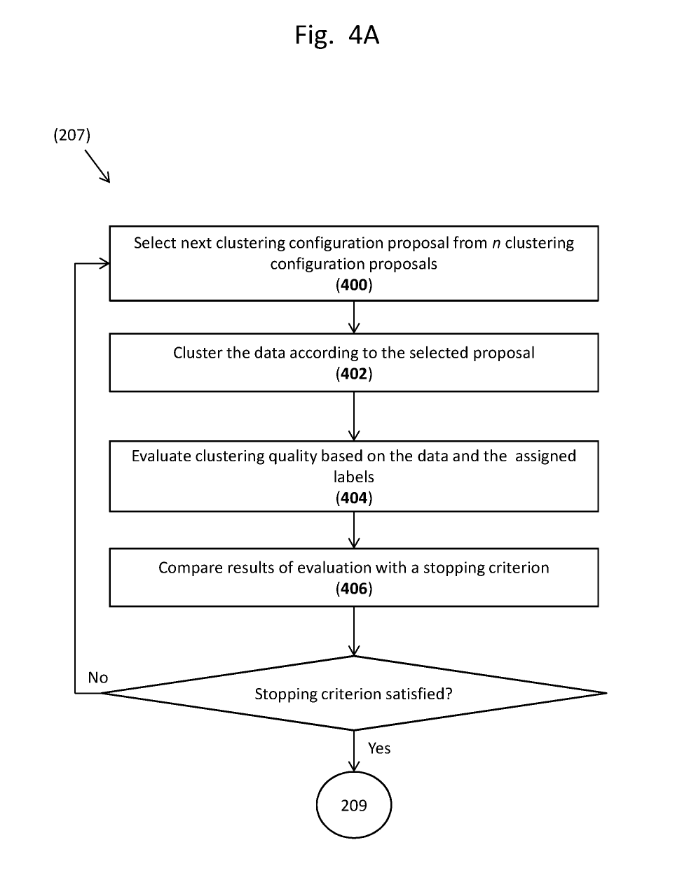

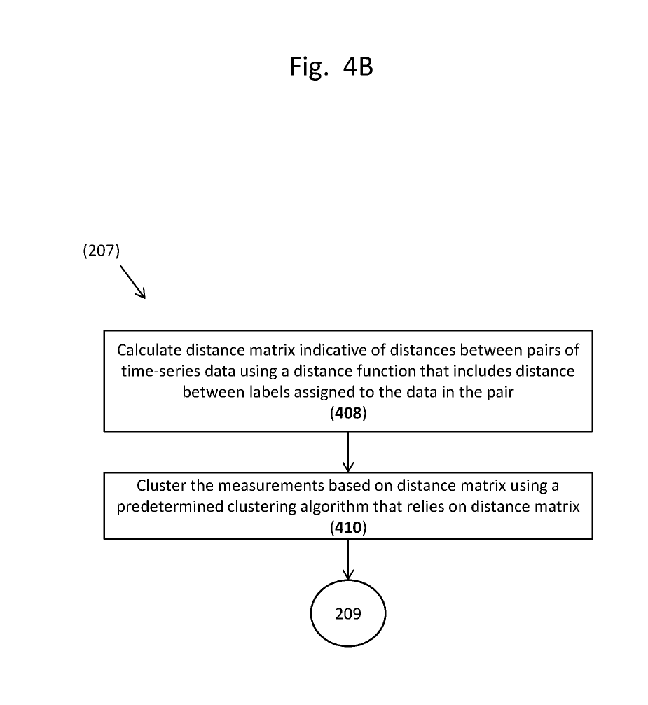

Next, processing unit (18), e.g. clustering engine (28), clusters (207) the time-series data that have been assigned labels into a set of clusters based at least partly on the assigned labels, i.e. using a clustering algorithm that takes into account the data itself (i.e. the values of the observations) as well as the labels assigned to the data, as will be further detailed below with reference to FIGS. 4A and 4B. In certain embodiments, clustering (207) can include pre-processing the time-series data prior to clustering in order to improve the clustering quality, e.g. by applying one or more of insertions (i.e. filling missing values), noise reduction, normalization, dimensionality reduction, etc.

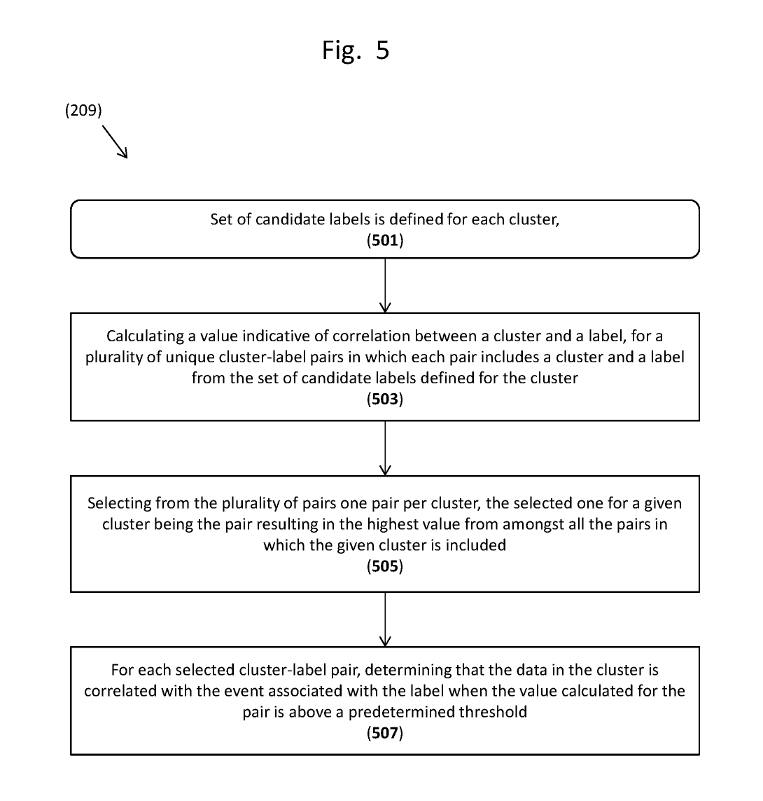

Upon the time-series data being clustered into a set of clusters based at least partly on the assigned labels, processing unit (18), e.g. correlator (32), correlates (209) each of one or more clusters of time-series data with respective events by evaluating a plurality of cluster-label pairs using a correlation metric, to thereby determine whether a correlation exists between the data in the cluster and the event associated with the label, as will be further detailed below with reference to FIG. 5.

In certain embodiments, processing unit (18) can further generate output indicative of the clusters of time-series data and their respective correlated event data. For example, the output can generated on a display device via a I/O interface. In certain embodiments processing unit (18) can be configured to detect anomalies, for example by “learning” the correlation between time-series data and event data, and detecting deviations from the expected pattern. In certain embodiments, processing unit (18) can further generate an alarm whenever an anomaly is detected.

In should be appreciated by those skilled in the art that the time-series data in any given cluster may be assigned different labels (i.e. some observations in the cluster assigned a first label, other observations a second label, still others a third label, etc.). Therefore, correlating the cluster to one event is a non-trivial task that seeks to determine which label (and therefore event) best fits the data in the cluster. It should further be appreciated that determining that a correlation exists between certain time-series data and events can be useful to unsupervisedly provide meaning to time-series data in the sense of being capable of explaining the underlying reasons for particular clusters of time-series data.

FIG. 4A illustrates a generalized flow chart of clustering (207) the time-series data based at least partly on the assigned labels, in accordance with a first embodiment. In this embodiment, different clustering configurations are iteratively tried, and subsequently evaluated for clustering quality using a metric that incorporates the labels assigned to the time-series data.

Processing unit (18), e.g. clustering engine (28), selects (400) a clustering configuration proposal from a clustering configuration space comprising n clustering configurations, and clusters (402) the time-series data based on the selected clustering configuration proposal. As used herein, a “clustering configuration” should be expansively construed to cover a particular clustering algorithm together with an associated set of parameters to be used with the particular clustering algorithm, and a “clustering configuration proposal” refers to a clustering configuration to try. By way of non-limiting example, clustering algorithms can include, e.g., hierarchical, DBSCAN, k-means, expectation-maximization, etc. For an overview of clustering methodologies, see, e.g.: Grira, N., Crucianu, M., & Boujemaa, N. (2004), Unsupervised and semi-supervised clustering: a brief survey, in ‘A Review of Machine Learning Techniques for Processing Multimedia Content’, Report of the MUSCLE European Network of Excellence (FP6).

In certain embodiments, selecting (400) a clustering configuration proposal from a clustering configuration space can include using known methods, such as e.g. a grid search (linearly sampling every clustering configuration in the clustering configuration space to try next), random search (randomly generating a clustering configuration), and/or using Bayesian optimization (building a statistical model of the configuration space and generate clustering configurations predicted to be good configurations to try next). In certain embodiments, clustering (402) can include assigning a cluster ID to each cluster.

Upon clustering, processing unit (18), e.g. optimizer (30), evaluates (404) the quality of the clustering by calculating a value indicative of a quality measure for the clustering using a metric that considers both the data itself (i.e. the observations) as well as the labels assigned to the data. Processing unit (18) further determines (406) whether a stopping criterion is satisfied. So long as the stopping criterion is not satisfied, the next clustering proposal is selected (400), and the same process is repeated. It should be noted that upon the stopping criterion being satisfied, the time-series data is presumed to be optimally clustered in accordance with the metric.

In certain embodiments, the value indicative of a quality measure for the clustering that considers both the data itself (i.e. the observations) as well as the labels assigned to the data can be, e.g., a silhouette score that uses a modified distance function that considers distance between data elements and, in addition, distance between labels assigned to the data elements. See, e.g., Peter J. Rousseeuw, “Silhouettes: a Graphical Aid to the Interpretation and Validation of Cluster Analysis”. Computational and Applied Mathematics 20: 53-65 (1987) for a general discussion of the silhouette score. The silhouette score can be used to assess cluster quality by calculating a given cluster's coherence and separation. Coherence refers to the cluster's similarity (i.e. proximity of data points assigned to the cluster). Separation refers to a cluster's dissimilarity to the nearest other cluster (i.e. distance between the data points assigned to the cluster and the data points assigned to the nearest other cluster).

The silhouette score S is calculated as the average of silhouette coefficients s(i):

$$S = \frac{1}{N} {\sum }_{i = 1}^{N} s ( i )$$

where the silhouette coefficient s(i) is calculated as:

$$s ( i ) = \frac{b ( i ) - a ( i )}{max \{ a ( i ) , b ( i ) \}}$$

$$where$$

$$a ( i ) = \frac{1}{{N}_{A}} {\sum }_{{m}_{j} ∈ A} dist ( {m}_{i} , {m}_{j} ) , where {m}_{i} ∈ A$$

$$and$$

$$b ( i ) = \frac{1}{{N}_{A}} {min}_{C} \{ {\sum }_{{m}_{j} ∈ C} dist ( {m}_{i} , {m}_{j} ) \} , where C \neq A$$

where A and C are clusters of data and mₓ is used to denote the x^{th} data element.

However, as noted, the prior art methods of calculating the distance between clustered data dist(mᵢ,mⱼ) including, e.g., Euclidean, Manhattan, cosine, Minkowski, etc., take into account only the data itself. As such, the presently disclosed subject matter proposes a modified distance function that incorporates, in addition, the distances between labels, thereby being useful to optimize the clustering according to both data and labels. By way of non-limiting example, the modified distance function can be, e.g.:

dist_{combined}(mᵢ,lᵢ,mⱼ,lⱼ)=distₘ(mᵢ,mⱼ)+α·distₗ(lᵢ,lⱼ)

where:

lᵢ, lⱼ are sets of labels assigned to vectors i and j, respectively;

mᵢ, mⱼ are data elements comprised in vectors i and j, respectively;

α is a weighting parameter with a default value of 1; and

distₘ, distₗ are suitable distance measures for vectors of data and labels, respectively.

By way of non-limiting example, a suitable distance measure distₘ can include vector space distance measures, e.g., Euclidean, Manhattan, cosine, Minkowski, etc. By way of non-limiting example, a suitable distance measure distₗ can include a distance measure that operates on sets, e.g. Jaccard distance, calculated as:

$${dist}_{Jaccard} ( {l}_{i} , {l}_{j} ) = 1 - \frac{\vert {l}_{i} ⋂ {l}_{j} \vert}{\vert {l}_{i} ⋃ {l}_{j} \vert}$$

In certain embodiments, the stopping criterion can be satisfied, e.g. upon the value indicative of a quality measure breaching a predetermined threshold (e.g. S>Sₜₕᵣₑₛₕ), and/or the maximum number of iterations breaching a predetermined threshold (e.g. nᵢₜₑᵣ>100), and/or the number of consecutive iterations with no improvement (including inconsequential improvement) to the value indicative of a quality measure breaching a predetermined threshold (e.g. nₙₒ_{_}ᵢₘₚᵣₒᵥ>10).

FIG. 4B illustrates a generalized flow chart of clustering (207) the time-series data based at least partly on the assigned labels, in accordance with a second embodiment. In this embodiment, the clustering is performed based on a distance metric which incorporates the labels assigned to the time-series data.

Processing unit (18), e.g. clustering engine (28), generates (408) a distance matrix indicative of distances between all pairs of time-series data (i.e. a pair of observations or a pair of vectors of observations) and labels, e.g. using the modified distance function detailed above with reference to FIG. 4A which incorporates the assigned labels in calculating the distance between pairs of time-series data. Processing unit (18) then clusters (410) the time-series data in accordance with the distance matrix, e.g. using a predetermined clustering algorithm that relies on a distance matrix to produce an optimized set of clusters. Non-limiting examples of such a clustering algorithm include, e.g. DBSCAN, affinity propagation, etc. In this embodiment, no cluster quality evaluation is required since the clustering algorithm already produces the set of clusters which are optimized based on the distance between time-series data having regard to both the data itself (i.e. the observations) and the labels assigned thereto.

It should be noted that a third embodiment is also possible, that being a hybrid of the first two embodiments. In the third embodiment, clustering is performed similar to the second embodiment (FIG. 4B), however clustering (410) using a distance matrix-based clustering algorithm can include first selecting a distance matrix-based clustering algorithm from a set of n distance matrix-based clustering algorithms, the selection being made on the basis of a quality measure, such as the highest silhouette score, as detailed above with respect to FIG. 4A.

Reference is now made to FIG. 5, illustrating a method of correlating (209) the data in a cluster with event data, in accordance with certain embodiments. First, a set of candidate labels is defined (501) for each cluster. The set of candidate labels can be the same for each cluster or they can be different for the different clusters. For example the set of candidate labels could include all labels. By way of non-limiting example, using the example provided in FIG. 3, assume the clustering produced two data clusters denoted C₁ and C₂, in which:
C₁={ν₁, ν₂}, C₂={ν₃, ν₄}

In such a scenario, the set of candidate labels for C₁ is {A, B, C, D, E}, and the set of candidate labels for C₂ is also {A, B, C, D, E}.

Alternatively, the set of candidate labels defined for a given cluster can include only those labels that are assigned to at least one observation in the given cluster. In such a scenario, the set of candidate labels for C₁ would be {A, B}, being labels assigned to at least one observation in C₁, and the set of candidate labels for C₂ would be {B, C, D, E}, being labels assigned to at least one observation in C₂.

Next, processing unit (18), e.g. correlator (32), calculates (503), for each of a plurality of unique cluster-label pairs, a value indicative of the correlation between the cluster and the label in the pair, where each cluster-label pair includes a cluster and a label from the set of candidate labels defined for the cluster. By way of non-limiting example, if C₁={ν₁, ν₂} and C₂={ν₃, ν₄}, and the set of candidate labels defined for each of clusters C₁ and C₂ is {A, B, C, D, E}, then the plurality of unique cluster-label pairs consists of the ten pairs: {C₁, A}, {C₁, B}, {C₁, C}, {C₁, D}, {C₁, E}, {C₂, A}, {C₂, B}, {C₂, C}, {C₂, D}, and {C₂, E}. The value indicative of correlation can include, e.g. a Phi coefficient, Jaccard similarity, etc., or other correlation metric.

Next, processing unit (18), e.g. correlator (32), selects (505) from the plurality of cluster-label pairs, one pair per cluster, the selected pair for each given cluster being the pair resulting in the highest value from amongst all the pairs in which the given cluster is included, as the below examples will illustrate. It is noted that it is also possible to select the top n-pairs per cluster, the pairs that show a sufficiently strong correlation or likewise.

Finally, processing unit (18), e.g. correlator (32), determines (507), for each selected cluster-label pair, that the data in the cluster is correlated with the event associated with the label whenever the value calculated for the pair and indicative of correlation meets or is above a predetermined threshold (e.g. 0.85, 0.9, etc.).

Non-limiting examples using Phi coefficients and Jaccard similarity as the correlation metric will now be provided. Continuing with the example provided above and in FIG. 3, assuming the set of candidate labels for both C₁ and C₂ is the set {A, B, C, D, E} there are ten cluster-label pairs to be evaluated using the correlation metric (five per cluster). Let Lₓ denote the data assigned with label x. Therefore:
L_{A}={ν₁, ν₂}
L_{B}={ν₁, ν₂, ν₃, ν₄}
L_{C}={ν₃}
L_{D}={ν₄}
L_{E}={ν₃}

### Example 1

This example uses the Phi coefficient as the correlation metric. The Phi coefficient ϕ for a cluster-label pair (X,C) is calculated as

$$φ ( X , C ) = \frac{\vert {L}_{x} ⋂ C \vert \vert {L}_{x}^{C} ⋂ {C}^{C} \vert - \vert {L}_{x} ⋂ {C}^{C} \vert \vert {L}_{x}^{C} ⋂ C \vert}{\sqrt{\vert {L}_{x} \vert \vert {L}_{x}^{C} \vert \vert C \vert \vert {C}^{C} \vert}}$$

where X^{C} denotes the set complement of X

For example, for cluster-label pair A, C₁ the Phi coefficient is calculated as

$$φ ( A , {C}_{1} ) = \frac{\vert {L}_{A} ⋂ {C}_{1} \vert \times \vert {L}_{A}^{C} ⋂ {C}_{1}^{C} \vert - \vert {L}_{A} ⋂ {C}_{1}^{C} \vert \times \vert {L}_{A}^{C} ⋂ {C}_{1} \vert}{\sqrt{\vert {L}_{A} \vert \times \vert {L}_{A}^{C} \vert \times \vert {C}_{1} \vert \times \vert {C}_{1}^{C} \vert}} = \frac{2 \times 2 - 0 \times 0}{\sqrt{2 \times 2 \times 2 \times 2}} = 1$$

In certain embodiments, the label can be selected if the Phi coefficient for the cluster-label pair is greater than a predetermined threshold, e.g. 0.9. It should be noted that if Phi coefficient is negative and absolute value is greater than the predetermined threshold, then the absence of the label can also be used to explain the data in some cases.

The following table illustrates the Phi coefficient calculated for each cluster-label pair in the example data:

| Cluster | Label A | Label B | Label C | Label D | Label E |
|---|---|---|---|---|---|
| C₁ | 1.0 | 0.0 | −0.577 | −1.0 | −0.577 |
| C₂ | −1.0 | 0.0 | 0.577 | 1.0 | 0.577 |

### Example 2

This example uses the Jaccard similarity coefficient as the correlation metric The Jaccard similarity coefficient J is calculated as

$$J ( X , C ) = \frac{\vert {L}_{x} ⋂ C \vert}{\vert {L}_{x} ⋃ C \vert}$$

The Jaccard similarity coefficient for each cluster-label pair is calculated. For example, for cluster-label pair A, C₁ the Jaccard similarity coefficient is calculated as

$$J ( A , {C}_{1} ) = \frac{\vert {L}_{A} ⋂ {C}_{1} \vert}{\vert {L}_{A} ⋃ {C}_{1} \vert} = \frac{\vert \{ {v}_{1} , {v}_{2} \} \vert}{\vert \{ {v}_{1} , {v}_{2} \} \vert} = 1$$

In certain embodiments, the label can be selected if the Jaccard similarity coefficient for the cluster-label pair is greater than a predetermined threshold (e.g. 0.9).

The following table illustrates the Jaccard similarity coefficient for each cluster-label pair in the example data:

| Cluster | Label A | Label B | Label C | Label D | Label E |
|---|---|---|---|---|---|
| C₁ | 1.0 | 0.5 | 0.0 | 0.0 | 0.0 |
| C₂ | 0.0 | 0.5 | 0.5 | 1.0 | 0.5 |

As illustrated above, for the example data, regardless of whether Phi or Jaccard is used as the correlation metric, in both cases the result is the same, i.e. the cluster-label pair {C₁, “A”} is associated, by way of non-limiting example, with the highest value from amongst the other pairs that include C₁, and the cluster-label pair {C₂, “D”} is associated with the highest value from amongst the other pairs that include C₂. Therefore in this example, the cluster of observations C₁ is determined to be correlated with the event corresponding to label “A” being E1 (namely a visit by the CEO), and the cluster of observations C₂ is determined to be correlated with the event corresponding to label “D” being E4 (namely a visit by a client). We may then conclude that there exists a causal link between the CEO's visit and the meeting room's appliance usage as observed in C₁, and a causal link exists between a visit by a client and the meeting room's appliance usage as observed in C₂.

As detailed above, the DP system disclosed herein can be used to correlate usage patterns of appliances (or any device) with events. In this embodiment, each observation can relate to the usage of a device in a particular environment, such as a home or office. Event data can be obtained from one or more calendars of persons using the environment, such as members of a household or employees in an office. The correlation between observations and events can be used to determine a linkage between certain events and the usage of devices in the environment.

By way of another example, the DP system disclosed herein can also be used to monitor the daily activity or routine of an individual using a combination of sensors that track the individual's activity. In this embodiment, each observation can relate to a user activity, and each event can be obtained from the individual's calendar. The correlation between observations and events can be used to determine a linkage between certain events and certain activities in the individual's daily routine and thereby explain the individual's observed behavior. For example, the DP system can be used in or in conjunction with an elder care patient monitoring system in which various sensors track certain day to day activities of the patient. By way of non-limiting example, a bed sensor tracks and records the time that patient gets into and out of bed, a fridge sensor tracks and records all instances of the fridge door opening, a sensor affixed to a medicine bottle tracks and records when the medicine is taken, and a television sensor tracks and records when the television is being watched. Using the DP system disclosed herein to process the observations and correlate those observations to events, e.g. a schedule of television programs, we might find that on Wednesday evening's a certain patient routinely watches television between 9:00-10:00 pm, neglects to take her 9:30 pm medicine and goes to bed after 10:30 pm, and that this pattern of behavior is correlated with events such as a weekly visit by the patient's relative, or the weekly airing of a specific television program, etc.

It is noted that the teachings of the presently disclosed subject matter are not bound by the flow charts illustrated in FIGS. 2, 4A, 4B, 5; the illustrated operations can occur out of the illustrated order. For example, operations (201) and (203) shown in succession can be executed substantially concurrently or in the reverse order. It is also noted that whilst the flow chart is described with reference to elements of system (10), this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A method of correlating observations recorded by one or more sensors with occurrences of one or more events, comprising:
by a processing unit operatively coupled to one or more data repositories:
obtaining from the one or more data repositories a first data set comprising data informative of the observations, each observation associated with a time;
obtaining from the one or more data repositories a second data set comprising data informative of the one or more events, each event associated with a label characterizing the event and a time range informative of the time of occurrence of the event, including at least a start time and an end time;
assigning to each observation of a plurality of observations in the first data set one or more labels associated with a respective one or more events that match the time of the observation, wherein an event matches the time of an observation whenever the time associated with the observation is within the time range associated with the event;
clustering the plurality of observations into a set of clusters based, at least partly, on the assigned labels;
correlating one or more clusters with corresponding events by:
i) calculating, for each cluster-label pair comprising a given cluster in the set of clusters and a given label in a set of candidate labels, a value indicative of a correlation between the cluster and the label in the cluster-label pair;
ii) selecting one cluster-label pair for each cluster, the selected cluster-label pair for a given cluster being the pair resulting in the highest value from amongst all other cluster-label pairs comprising the given cluster;
iii) for each selected cluster-label pair in respect of which the resulting value is above a predetermined threshold, determining that the cluster is correlated with the event with which the label is associated; and
generating output indicative of at least one such correlation.

2. The method of claim 1 wherein clustering the plurality of observations into a set of clusters comprises:
(a) selecting a clustering configuration proposal from a clustering configuration space comprising one or more predetermined clustering configurations;
(b) clustering the observations in accordance with the obtained clustering configuration proposal;
(c) evaluating a quality measure of the clustering using a metric that considers the observations and the labels assigned thereto; and
(d) iterating through steps (a) to (c) until a stopping criterion is satisfied.

3. The method of claim 2 wherein the metric is a modified Silhouette score such that the distance function of the Silhouette score also considers the distance between labels.

4. The method of claim 2 wherein the stopping criterion is satisfied upon one or more of:
(a) a value indicative of the quality measure breaching a predetermined threshold;
(b) the number of iterations breaching a predetermined threshold; and
(c) the number of consecutive iterations with no improvement to a value indicative of the quality measure breaching a predetermined threshold.

5. The method of claim 2 wherein a clustering configuration proposal is selected using one or more of a grid search, random search, and Bayesian optimization.

6. The method of claim 1 wherein clustering the plurality of observations into a set of clusters comprises:
generating a distance matrix indicative of distances between all pairs of observations or pairs of vectors of observations, said distances also considering the labels assigned to the pairs of observations or pairs of vectors of observations, and
clustering the plurality of observations in accordance with said distance matrix using a distance-matrix based clustering algorithm.

7. The method of claim 1 wherein the set of candidate labels for a given cluster is selected from the group consisting of: i) all labels, and ii) only those labels assigned to at least one observation in the given cluster.

8. The method of claim 1 wherein the value indicative of a correlation comprises one of a Phi coefficient and a Jaccard similarity coefficient.

9. The method of claim 1 wherein each observation relates to an activity in a daily routine of an individual, and each event is obtained from the individual's calendar, and wherein the correlated data is used to determine a linkage between certain events and certain activities in the individual's daily routine.

10. The method of claim 1 wherein each observation relates to a usage of a device in an environment, and each event is obtained from one or more calendars of persons in the environment, and wherein the correlated data is used to determine a linkage between certain events and the usage of devices in the environment.

11. A system for correlating observations recorded by one or more sensors with occurrences of one or more events, comprising:
one or more data repositories; and
a processing unit operatively coupled to the one or more data repositories and configured to:
obtain from at least one of the one or more data repositories a first data set comprising data informative of the observations, each observation associated with a time;
obtain from at least one of the one or more data repositories a second data set comprising data informative of the one or more events, each event associated with a label characterizing the event and a time range informative of the time of occurrence of the event, including at least a start time and an end time;
assign to each observation of a plurality of observations in the first data set one or more labels associated with a respective one or more events that match the time of the observation, wherein an event matches the time of an observation whenever the time associated with the observation is within the time range associated with the event;
cluster the plurality of observations into a set of clusters based, at least partly, on the assigned labels;
correlate one or more clusters with corresponding events by:
i) calculating, for each cluster-label pair comprising a given cluster in the set of clusters and a given label in a set of candidate labels, a value indicative of a correlation between the cluster and the label in the cluster-label pair;
ii) selecting one cluster-label pair for each cluster, the selected cluster-label pair for a given cluster being the pair resulting in the highest value from amongst all other cluster-label pairs comprising the given cluster;
iii) for each selected cluster-label pair in respect of which the resulting value is above a predetermined threshold, determining that the cluster is correlated with the event with which the label is associated; and
generate output indicative of at least one such correlation.

12. The system of claim 11 wherein the processing unit is configured to cluster the plurality of observations into a set of clusters by:
(a) selecting a clustering configuration proposal from a clustering configuration space comprising one or more predetermined clustering configurations;
(b) clustering the observations in accordance with the obtained clustering configuration proposal;
(c) evaluating a quality measure of the clustering using a metric that considers the observations and the labels assigned thereto; and
(d) iterating through steps (a) to (c) until a stopping criterion is satisfied.

13. The system of claim 12 wherein the metric is a modified Silhouette score such that the distance function of the Silhouette score also considers the distance between labels.

14. The system of claim 12 wherein the stopping criterion is satisfied upon one or more of:
(a) a value indicative of the quality measure breaching a predetermined threshold;
(b) the number of iterations breaching a predetermined threshold; and
(c) the number of consecutive iterations with no improvement to a value indicative of the quality measure breaching a predetermined threshold.

15. The system of claim 12 wherein a clustering configuration proposal is selected using one or more of a grid search, random search, and Bayesian optimization.

16. The system of claim 11 wherein the processing unit is configured to cluster the plurality of observations into a set of clusters by:
generating a distance matrix indicative of distances between all pairs of observations or pairs of vectors of observations, said distances also considering the labels assigned to the pairs of observations or pairs of vectors of observations, and
clustering the plurality of observations in accordance with said distance matrix using a distance-matrix based clustering algorithm.

17. The system of claim 11 wherein the set of candidate labels for a given cluster is selected from the group consisting of: i) all labels, and ii) only those labels assigned to at least one observation in the given cluster.

18. The system of claim 11 wherein the value indicative of a correlation comprises one of a Phi coefficient and a Jaccard similarity coefficient.

19. The system of claim 11 wherein each observation relates to an activity in a daily routine of an individual, and each event is obtained from the individual's calendar, and wherein the correlated data is used to determine a linkage between certain events and certain activities in the individual's daily routine.

20. The system of claim 11 wherein each observation relates to a usage of a device in an environment, and each event is obtained from one or more calendars of persons in the environment, and wherein the correlated data is used to determine a linkage between certain events and the usage of devices in the environment.

21. A non-transitory storage medium comprising instructions that when executed by a processing unit, cause the processing unit to perform a method of correlating observations recorded by one or more sensors with occurrences of one or more events, the method comprising:
obtaining from one or more data repositories a first data set comprising data informative of the observations, each observation associated with a time;
obtaining from one or more data repositories a second data set comprising data informative of the one or more events, each event associated with a label characterizing the event and a time range informative of the time of occurrence of the event, including at least a start time and an end time;
assigning to each observation of a plurality of observations in the first data set one or more labels associated with a respective one or more events that match the time of the observation, wherein an event matches the time of an observation whenever the time associated with the observation is within the time range associated with the event;
clustering the plurality of observations into a set of clusters based, at least partly, on the assigned labels;
correlating one or more clusters with corresponding events by:
i) calculating, for each cluster-label pair comprising a given cluster in the set of clusters and a given label in a set of candidate labels, a value indicative of a correlation between the cluster and the label in the cluster-label pair;
ii) selecting one cluster-label pair for each cluster, the selected cluster-label pair for a given cluster being the pair resulting in the highest value from amongst all other cluster-label pairs comprising the given cluster;
iii) for each selected cluster-label pair in respect of which the resulting value is above a predetermined threshold, determining that the cluster is correlated with the event with which the label is associated; and
generating output indicative of at least one such correlation.
